(19) United States
(12) Patent Application Publication
(10) Pub. No.: US 2025/0116865 A1
(43) Pub. Date: Apr. 10, 2025

(54) EYEGLASS LENS WITH WAVEGUIDE

(71) Applicant: TRULIFE OPTICS LIMITED, London Greater London (GB)

(72) Inventors: Andrii VOLKOV, London Greater London (GB); Helen SMITH, London Greater London (GB)

(73) Assignee: TRULIFE OPTICS LIMITED, London Greater London (GB)

(21) Appl. No.: 18/728,656

(22) PCT Filed: Jan. 13, 2023
(86) PCT No.: PCT/EP2023/050715

§ 371 Date: Jul. 12, 2024

(30) Foreign Application Priority Data
Jan. 20, 2022 (GB) 2200718.1

(51) Int. Cl. G02B 27/01

(52) U.S. Cl. CPC G02B 27/0172; G02B 2027/0178

(57) ABSTRACT

The present disclosure relates to an augmented reality eyeglass lens with a waveguide and a method of manufacturing such an eyeglass lens with a waveguide. The eyeglass lens including: a first lens part and a second lens part, with a cylindrical waveguide therebetween; and the cylindrical waveguide having cylindrical concentric opposing surfaces defining a first cylindrical interface with the first lens part and a second cylindrical interface with the second lens part, and the cylindrical waveguide is transparent and includes central waveguide core with a transparent medium at the first and second cylindrical interfaces.

### CROSS-REFERENCE TO RELATED APPLICATIONS

This application is a national stage application, filed under 35 U.S.C. § 371, of International Patent Application No. PCT/EP2023/050715, filed on Jan. 13, 2023, which claims priority to United Kingdom Patent Application No. 2200718.1, filed on Jan. 20, 2022, the entire contents of each of which is incorporated by reference herein in its entirety.

### BACKGROUND

### 1. Field of the Disclosure

The present disclosure relates to an eyeglass lens comprising a waveguide for an augmented reality display and a method of manufacturing an such an eyeglass lens comprising a waveguide.

### 2. Description of the related art

In the field of augmented reality (AR), a virtual image is displayed to a user overlaid on the real world using a transparent combiner which redirects an image from a projector system to a user's eye. Current solutions typically employ planar transparent waveguides formed from a glass or plastic material, where light from the projector is in-coupled to the waveguide via a diffraction grating and traverses along a longitudinal direction of the waveguide by total internal reflection and out-coupled by a further diffraction grating to a user's eye. In such applications the thickness of the waveguide is typically a few millimetres (mm).

Transparent combiner solutions based on free space reflective optics exist but these typically have a small area (also known as the eye-box) where the image or array of such images are viewable by a user. Free space reflective optics are therefore unsuitable for applications where a large eye-box is required. A small eye-box area would require the AR glasses to be mechanically adjusted or fitted to a particular user due to variation in inter-pupillary distance (IPD), thus increasing cost and complexity. Planar waveguide-based solutions on the other hand have a large eye-box area which means that a single variation of a design of AR glasses can fit most of the user population and the user can easily see the virtual image.

It is known to embed waveguides, of the type described above, within eyeglass lenses and this is desirable for many reasons. Specifically, in AR applications the in-coupling and out-coupling diffraction gratings may be holographic optical elements (HOEs) with a thickness of less than one millimetre (mm). However, there are limitations to embedding such waveguides within lenses. Typically, lenses used in glasses are curved particularly where the lenses are prescription lenses, whereas the waveguides are flat. Therefore, embedding waveguides in curved lenses has the disadvantage that the thickness of lenses must be larger, and therefore heavier, to accommodate the flat waveguide.

A number of approaches exist for encapsulating thin films within lenses or laminating thin films on eyeglasses. Whilst such approaches may be useful for incorporating HOEs with a thickness of less than one millimetre, they are not suitable for use with waveguides of several millimetres thickness that are encapsulated within an eyeglass lens. Furthermore, none of the known solutions discuss the problems associated with achieving the required refractive index change within an eyeglass lens to ensure that light rays can be efficiently guided from a light source to a user's eye to replicate a pupil in a continuous way without rays from the same image pixel diverging when projected at infinity.

### SUMMARY

There is provided an eyeglass lens for an augmented reality display, the eyeglass lens comprising: a first lens part and a second lens part, with a cylindrical waveguide therebetween; the cylindrical waveguide having cylindrical concentric opposing surfaces defining a first cylindrical interface with the first lens part and a second cylindrical interface with the second lens part, and wherein the cylindrical waveguide is transparent and comprises central waveguide core with a transparent medium at the first and second cylindrical interfaces.

The central core may have a higher refractive index than the transparent medium and the transparent medium is an adhesive material, or an air gap. The first lens part, second lens part, cylindrical waveguide and transparent medium are arranged as an optical stack.

The eyeglass lens may have a major axis and a minor axis, the first and second cylindrically shaped interfaces having a curved profile along the major axis. The first and second cylindrically shaped interfaces may have a linear profile along the minor axis. The first lens part and the second lens part have a spherical outer profile.

The eyeglass lens may further comprise input optics, wherein the input optics are configured and arranged to couple light into the cylindrical waveguide. The input optics may comprise an in-coupling linear diffraction grating having a constant period, applied to a surface of the waveguide. The in-coupling linear diffraction grating may be attached to the waveguide at the first cylindrical interface or the second cylindrical interface. The in-coupling linear diffraction grating may be switchable. The in-coupling linear diffraction grating may be formed of a holographic material.

The input optics may be configured and arranged to receive light rays from an image source and to cause the light rays to enter the cylindrical waveguide such that all light rays originating the from a same pixel of the image source are incident on the surface of the cylindrical waveguide at the same angle relative to the surface normal and at the same angle relative to a plane normal to the common cylinder axis, at each point of incidence, the in-coupled light thereby retaining its direction angle as it propagates along the cylindrical waveguide.

The eyeglass lens may further comprise output optics configured and arranged to receive propagated light from the cylindrical waveguide and present the light as an image to a user's eye. The output optics may comprise an out-coupling linear diffraction grating having a constant period, applied to a surface of the waveguide. The out-coupling linear diffraction grating may be attached to the waveguide at the first cylindrical interface or the second cylindrical interface. The out-coupling linear diffraction grating may be switchable.

The out-coupling linear diffraction grating may be formed of a holographic material. The out-coupling linear diffraction grating may be attached to the waveguide at the first cylindrical interface or the second cylindrical interface.

There is also provided a method of manufacturing an eyeglass lens for an augmented reality display, the method comprising; forming a first lens part and a second lens part and inserting a cylindrical waveguide therebetween; forming the cylindrical waveguide with cylindrical concentric opposing surfaces defining a first cylindrical interface with the first lens part and a second cylindrical interface with the second lens part, and wherein the cylindrical waveguide is transparent and comprises central waveguide core with a transparent medium at the first and second cylindrical interfaces.

The central core may have a higher refractive index than the transparent medium. The transparent medium may be an adhesive material. The transparent medium may be an air gap. The first lens part, second lens part, cylindrical waveguide and transparent medium may be arranged as an optical stack.

Advantageously therefore, the eyeglass lens for augmented reality displays is encapsulated with a curved waveguide within the lens which provides for replicated eye-boxes with substantially reduced aberrations

### BRIEF DESCRIPTION OF THE DRAWINGS

So that the manner in which the features of the present disclosure can be understood in detail, a more particular description is made with reference to embodiments, some of which are illustrated in the appended figures. It is to be noted, however, that the appended figures illustrate only typical embodiments and are therefore not to be considered limiting of its scope. The figures are for facilitating an understanding of the disclosure and thus are not necessarily drawn to scale. Advantages of the subject matter claimed will become apparent to those skilled in the art upon reading this description in conjunction with the accompanying figures, in which like reference numerals have been used to designate like elements, and in which:

FIG. 1a illustrates schematically a perspective view of an eyeglass lens with waveguide according to an embodiment.

FIG. 1b illustrates schematically an exploded top-down view of an eyeglass lens with waveguide according to an embodiment.

FIG. 1c illustrates schematically a side view of an eyeglass lens with waveguide according to an embodiment.

FIG. 2 illustrates schematically the waveguide for the eyeglass lens according to an embodiment.

FIG. 3 illustrates schematically in-coupling optics for the waveguide of the eyeglass lens according to an embodiment.

FIG. 4 illustrates schematically in-coupling and out-coupling optics for the waveguide of the eyeglass lens according to an embodiment.

FIG. 5 illustrates schematically a light source, in-coupling and out-coupling optics and a user's eye for the waveguide of the eyeglass lens according to an embodiment.

FIG. 6 illustrates schematically out-coupling optics for the waveguide of the eyeglass lens according to an embodiment.

FIG. 7a illustrates schematically a perspective view of an eyeglass lens with waveguide according to an embodiment.

FIG. 7b illustrates schematically an exploded top-down view of an eyeglass lens with waveguide according to an embodiment.

FIG. 7c illustrates schematically a side view of an eyeglass lens with waveguide according to an embodiment.

### DETAILED DESCRIPTION

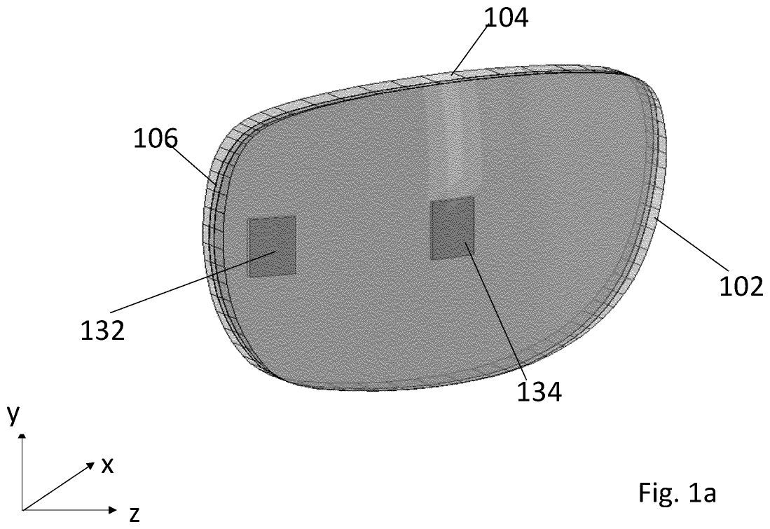

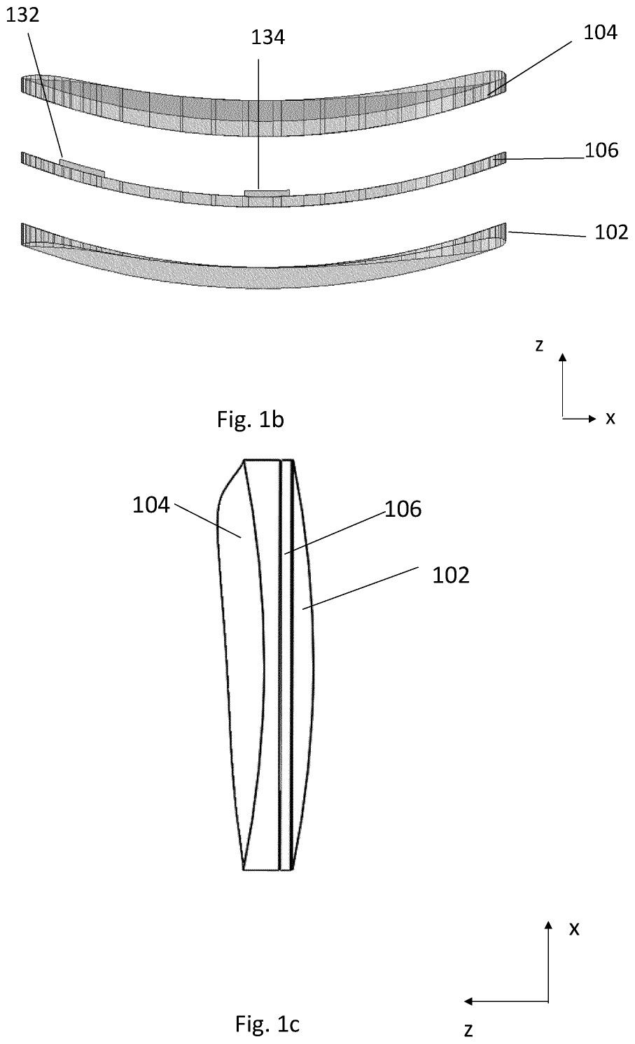

In general overview and as illustrated schematically in FIGS. 1a to 1c, the eyeglass lens 100, according to an embodiment comprises: a first lens part 102; a second lens part 104 (also known as the first lens half and the second lens half respectively), and a waveguide 106 (also known as a light guide) interposed between the first and second lens parts 102, 104. In this way, the first and second lens parts 102, 104 and the waveguide 106 are arranged as an optical stack. The waveguide 106 has first and second opposing surfaces designated respectively as eye facing and world facing surfaces. Likewise, the first lens part 102 is designated as a world facing lens because when in use it is on a side of the waveguide 106 facing the world. The second lens part 104 is designated as an eye facing lens because when in use it is on the side of the waveguide facing a user's eye. The stacked arrangement of lens parts 102, 104 and waveguide 106 are transparent to the real world, that is a user will be able to view the world through the eyeglass lens 100.

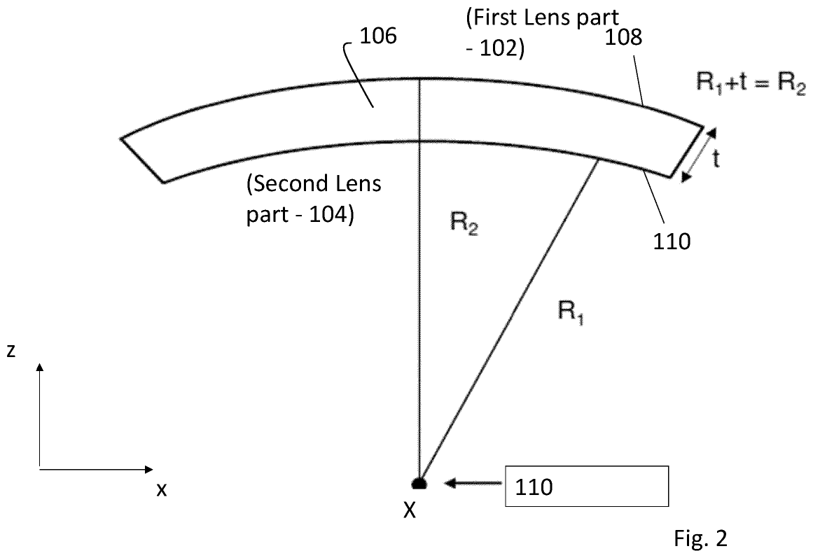

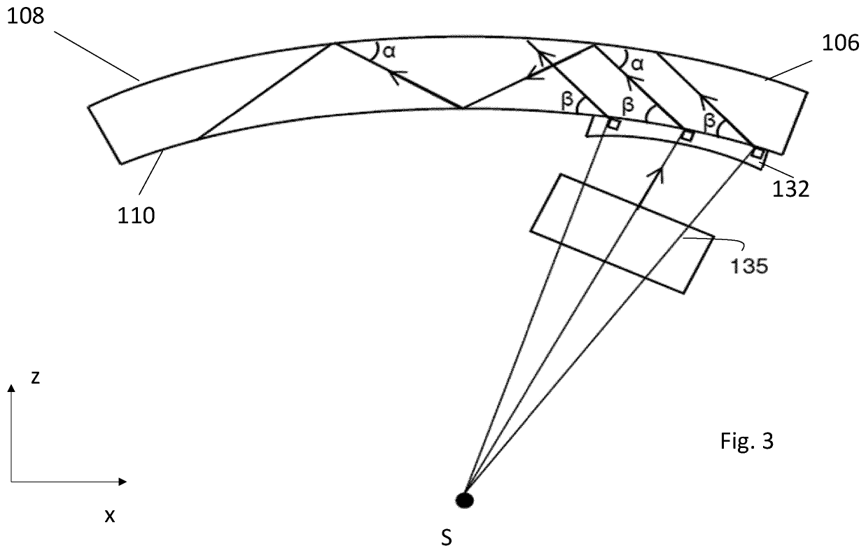

The waveguide 106 of the type utilised in the eyeglass lens 100, is illustrated schematically in FIG. 2 where the lens parts 102, 014 have been omitted for clarity, but their position is indicated for reference. The waveguide 106 is cylindrical in shape and comprises the first and second concentric opposing surfaces 108, 110 with a constant thickness t between the opposing surfaces 108, 110. A centre of curvature of the waveguide 106 is designated as X. The distances designated R₁ and R₂ are radii of curvature between the centre of curvature and the respective opposing concentric surface 108, 110. In this way, it can be seen that a concave side of the cylindrical waveguide 106 is eye facing, as discussed in more detail below. Similarly, the distance from the centre of curvature X to the inner or eye facing surface 110 of the waveguide 106 is R₁ and the distance from the centre of curvature X to the outer surface (world facing) 108 of the waveguide 106 is R₂. It is clear that R₂=R₁+t and due to the constant thickness t, this applies irrespective of where on the cylindrical waveguide 106 the distances R₁ and R₂ are measured. In other words, the waveguide 106 has a common centre of curvature X and the radii R₁ and R₂ of the inner 110 and outer 108 surfaces of the waveguide 106 are separated by thickness t, which is constant.

With reference to FIGS. 1a and 1b, an in-coupling diffraction grating 132 may be provided on the surface of the waveguide 106 to input light from a light source into the waveguide 106. A corresponding out-coupling diffraction grating 134 may be provided on the surface of the waveguide to output light from the waveguide to a user's eye. The in-coupling and out-coupling diffraction gratings 132, 134 may be positioned on the waveguide 106 such that it sits within the footprint of the first and second lens parts as they are affixed to the concentric opposing surfaces of the waveguide 106.

Using a cylindrical waveguide 106 of such a structure may allow light to travel between the curved surfaces without aberration. This is advantageously implemented together with input optics, such as lenses prisms mirrors and so on, that are arranged to receive light from an image source (particularly, a pixelated image source or an image source having a light output that can at least notionally be divided into pixels) and to provide the light to the cylindrical waveguide 106. All rays from the same pixel of the image source are incident on the cylindrical waveguide 106 at the same angle relative to an incidence surface normal at each point of incidence. All rays from a central pixel of the image source are therefore incident at any point on the cylindrical waveguide 106, normal to the cylindrical surface. Rays from non-central pixels are incident at the same angle relative to the surface normal at each point of incidence. Moreover, all rays from the same pixel of the image source are incident on the cylindrical waveguide 106 at the same angle relative to a plane normal to the cylinder axis at each point of incidence. Thus, the direction of propagation of all of the rays remains the same.

In view of the input optics as illustrated in FIG. 3 and the waveguide structure as described above, light received at the cylindrical waveguide (typically in-coupled to the cylindrical waveguide) retains its direction angle as it propagates along the cylindrical waveguide. That is, all the rays from a given pixel, no matter how far propagated, will approach an output grating at the same angle as measured between the ray and the surface, at the point of the incidence of each ray. Typically, the input optics comprises in-coupling (or injection) optics.

Unlike traditional collimating optics used for flat waveguides, the input optics proposed in this disclosure would not be correctly termed a collimator in classical optical design terminology, because the rays from a pixel are not parallel. Rather, the preferred in-coupling (projector) optics comprise an optical device arranged to collimate or conform light (only) in a plane passing through (that is, neither parallel to nor entirely including) and more preferably, perpendicular to the cylinder axis. For glasses and helmets, for instance, the cylinder axis is vertical, and the plane is preferably horizontal. In this way, the rays are incident on the input grating 132 at the same angle in this plane. A wavefront shaping device 135, for example a cylindrical lens and/or mirror, can be used for this task. As is usual in optical design best practices, the central pixel rays would advantageously be incident at an angle normal to the surface of the waveguide 106, to make aberration management easier because of symmetry. Other pixels in this plane would produce rays incident on the input grating at other angles, but would be parallel to other rays from the same pixel.

However, in a plane orthogonal to the cylinder axis for instance, a horizontal plane, the light may not be collimated, but rather shaped in such a way that rays from the same pixel have the same angle of incidence with respect to surface normal, where this normal is considered separately for each different point of incidence. The wavefront shape satisfying this condition is the cylindrical wavefront which is concentric with the cylindrical shape of the waveguide. The rays from the central pixel would then propagate radially from the waveguide cylinder axis and approach the surface at normal incidence. This wavefront is advantageously formed by positioning the image source S (display) with a centre of the image source at the waveguide axis. The cylindrical lens 135 or mirror is then arranged to have optical focussing power only in a vertical plane.

Optionally additional, or different input optics may be provided, for example to optimise the performance for more or all pixels and/or to minimise the volume of the projector. This may include utilising optics with focusing in a horizontal plane to bring the display closer. Where a concave mirror is used, the image source and/or in-coupling optics may be arranged such that light approaches the waveguide from the opposite side of the waveguide from the mirror before being reflected and then diffracted.

Light may propagate through the cylindrical waveguide 106 (for example, between the in-coupling optics and the out-coupling optics) in a direction (defined by a vector) that is parallel to the cylinder axis (for instance, vertical) or a direction (defined by a vector) that is perpendicular to the cylinder axis (which may be horizontal, specifically around the circumference of the waveguide) or a direction defined by a vector that is between parallel and perpendicular to the cylinder axis (typically, diagonal).

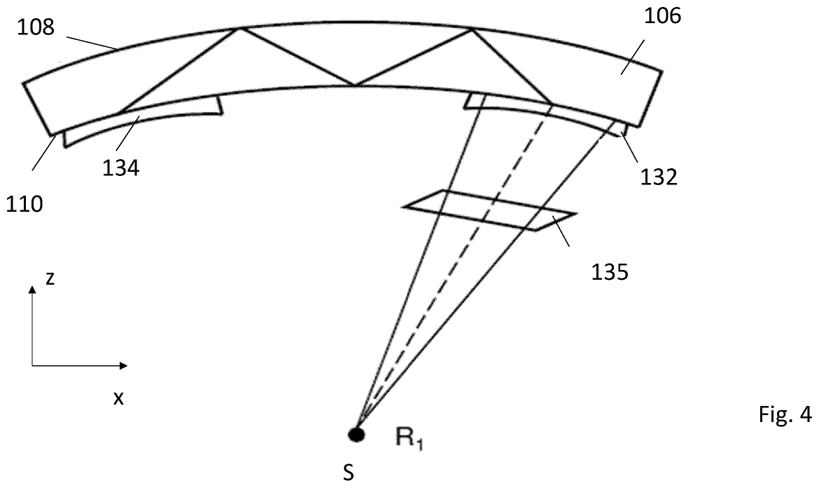

As illustrated in FIG. 4, the out-coupling optics typically comprises an out-coupling diffraction grating 134vas mentioned above. In principle, a linear grating could be used. However, a practical use of the waveguide 106 is with the viewer on the inside of the cylinder. Therefore, a simple linear grating may not be appropriate to extract the light in such circumstances, as it will focus it in a horizontal plane at the cylinder axis (resulting in a vertical line of light), rather than far ahead of the viewer. In contrast, a diverging lens property may collimate the light in the horizontal direction (in the vertical direction it is already collimated). This may be achieved by adding a negative optical power to the output grating in the horizontal direction. By analogy, the grating is the sum of a prism function and a cylindrical negative lens function. There are many known examples of how to record such a grating. Such a grating will not be termed “linear” in contrast to the input grating. The output grating can be chosen to place the digital image at any distance from the viewer by adding more focusing power in both planes.

In cases where the cylindrical waveguide 106 is embedded inside a head-mounted structure that already corrects for the eyesight of the user (for instance, prescription glasses), the input and output gratings may also be corrected to take this into account.

The main factor is to preserve the aforementioned conditions of the light as it propagated inside the waveguide regardless of how the light approached and leaves the “sandwich” of the overall optical stack.

The waveguide 106 of the type discussed above is placed between the first and second lens halves 102 and 104 to form the eyeglass lens 100. FIG. 1a illustrates the finally formed eyeglass lens 100, whereas FIG. 1b illustrates an exploded view of first and second lens halves 102, 104 with the waveguide 106 therebetween. The first lens half 102 has a spherical external front or outer, world facing, surface and a cylindrical back surface which has a radius of curvature such that it conforms to and is mateable with the radius of curvature R₂ of the world facing surface 108 of the waveguide 106. The second lens half 106 has a cylindrical external front or world facing surface which has a radius of curvature such that it conforms to and is mateable with the radius of curvature R₁ of the eye facing surface 108 of the waveguide 106, and a spherical back or outer world facing, surface. It can be seen that the thickness t of the waveguide 106 across its circumference is equal or constant. In this way the skilled person will understand that the waveguide 106, and the associated in-coupler 132 and out-coupler 134 is placed between the between the first and second lens halves 102, 104. Referring to FIG. 1c, a side view of the eyeglass lens 100 illustrates the waveguide 106 mateably interposed between the first and second lens parts 102, 104 and it can be seen that the thickness t of the waveguide 106 down its vertical edge is equal or constant and in this way the waveguide is flat in one axis. It can be seen therefore that the cylindrical surface of the first lens part 102 is concentric with the cylindrical surface of the second lens part 104 and the remaining surfaces are therefore spherical. The constant thickness of the waveguide across its circumference and down its vertical edge ensures that light rays propagate uniformly through the waveguide. In this way the waveguide 106, from an optical point of view can be considered a plane lens because it has zero optical power and does not contribute to the optical power of the eyeglass lens.

In each of FIGS. 1a to 1c, (x-), (y-) and (z-) axes are indicated for reference purposes and these references will be used consistently herein. With reference to FIG. 1a, the eyeglass lens 100 according to embodiments has a major axis in the horizontal (x) direction and a minor axis in the vertical (y) direction and a depth (z) direction. The depth (z) dimension is of the eyeglass lens is typically significantly smaller, by about a factor of 10, compared to the dimensions in the (x) or (y) directions.

Simple spherical lenses may be used for zero power lenses in applications such as off the shelf sunglasses and ski goggles. In such applications the eye facing and world facing surfaces have spherical curvature where the world facing surface curvature is known as base curvature, and the two surface profile curvatures are non-concentric. The base curvature of a lens provides the best optical performance of the lens whilst also achieving optimum aesthetics and reduce the weight of the lens. For example, a 6-dioptre curve front (world facing) lens surface, corresponds to a radius of curvature of approximately 83 mm, is considered the best form, based on empirical data to give the best peripheral vision for most users. For aesthetic reasons, reading glasses and fashion lenses can have flatter surfaces with a typical base curve being 4 dioptres and, in this case, the first lens part 102 would have a base curve of +4 dioptres and the second lens part would have a base curve of −4 dioptres (giving a net zero (0) dioptres). Typically, the front, world facing surface of the first lens part 102 is curved such that it gives better visual acuity, especially when compared to a plano-convex lens, and improves the visual acuity across the user's field of view. To correct for astigmatism the power may be added to the eye facing surface of the second lens part 104. In terms of astigmatism, the second lens part 104 may have a base curve chosen to correct for an astigmatism of a user's eye and to correct for the astigmatism of the cylindrical waveguide 106 where the amount of astigmatism of the cylindrical waveguide 106 will be dependent on the radii of curvature R₁ and R₂. Similarly, to correct for short-sightedness or long-sightedness, net power may be added (or subtracted) by changing the power of the second lens part 106.

By way of non-limiting example, the eyeglass lens 100 according to embodiments may have a horizontal dimension (x-axis) of 55 mm and a vertical dimension (y-axis) of 32 mm and a combined thickness (z-axis) of the first and second lens parts 102, 104 of 2 mm in the case of a zero-power stock lens. The eye facing surface of the second lens part 104 may have a radius of curvature 150 mm (approximately 3.3 dioptres). The world facing surface of the first lens part 102 may have a radius of curvature of 152 mm. The eye facing surface of the first lens part 102 and the world facing surface of the second lens part 104 is cylindrically curved in the xz plane and flat in the yz plane and flat in the xy plane. The cylindrical curved surface of the first lens part 102 will have a radius of curvature of 125 mm in the x-axis and cylindrical curved surface of the second lens part will have a radius of curvature of 126 mm in the x-axis. The profile of the cylindrical surfaces of the first and second lens parts 102, 104 is flat in the y-axis. The difference of radii of curvatures accounts for the thickness of the cylindrical waveguide 106 and allows for conformal attachment of the concentric surfaces of waveguide 106 to the cylindrical surface of the first and second lens parts 102, 104.

According to the present disclosure the waveguide 106 may have a thickness t of between 0.1 mm to 10 mm and preferably between 0.5 mm and 2 mm and the radii of curvature R₁ and R₂ of based on a lens curvature of between 2 and 6 dioptres would give radii between 80 and 300 mm. The first and second lens parts 102, 104 may typically fabricated separately, but may optionally be formed by dividing or splitting a single eyeglass lens. The cylindrical surface profiles of the first and second lens parts 102, 014 may be made by grinding or injection moulding or a combination of the two. Optionally 3D printing may be used to make the lens parts. Lens grinding and mould manufacture processes may use diamond grinding to achieve the cylindrical surfaces.

Referring to FIGS. 1a, 1b and 2, the eye facing surface of the first lens part 102 and the world facing surface of the second lens part 104 define a cylindrical interface into which the waveguide 106 mateably conforms. As a non-limiting example mentioned above, the radius of curvatures of the cylindrical surfaces of the first lens part 102 and the second lens part 104 may be 126 mm and 125 mm respectively, defining a waveguide thickness of 1 mm. Since the waveguide is conformal with the cylindrical surfaces of the first and second lens parts 102, 104 their respective radii of curvature will be the same as the corresponding surface of the waveguide 106. In other words, the eye facing surface of the first lens part 102 will have a radius of curvature equal to R₁ and the world facing surface of the second lens part 104 will have a radius of curvature equal to R₂. The first lens part 102 will be thicker in the middle section than the outer sections whereas for positive user prescriptions the second lens part outer sections will be thicker than the middle section or for negative user prescriptions the second lens part outer sections will be thinner than the middle.

Whilst the foregoing discussion relates to purely cylindrical surfaces of the first and second lens parts 102, 104 and the surfaces of the waveguide 106, the skilled person will appreciate that those surfaces may be partially spherocylindrical or toric provided that any deviation from the purely cylindrical shape is negligible and provided that the thickness of the waveguide 106 remains constant.

The waveguide 106 may be attached to the first and second lens parts 102, 104 by any appropriate means. For example, the waveguide 106 may be attached by means of a transparent adhesive applied over each of the cylindrical surfaces of either the first and second lens parts 102, 104 or the waveguide 106, or both. The transparent adhesive may be a low refractive index material such as for example Norland Optical Adhesive 1315 which has a refractive index of 1.315. This has the advantage that the adhesive serves to both mechanically fix the first and second lens parts 102, 104 to the waveguide 106, but also maintain the refractive index difference required to allow total internal reflection in the waveguide. As an example, the thickness of the transparent adhesive would be between 20 μm-100 μm. The adhesive may also be an adhesive film or tape, or a liquid adhesive. Furthermore the adhesive may be seen as a transparent medium with acts as a cladding material of the waveguide 106, necessary to achieve the above-mentioned refractive index difference. For example where the thickness of the adhesive is 0.1 μm and applied on both of the concentric cylindrical surfaces of the waveguide 106, an appropriate adjustment may be made to the radii of the cylindrical surfaces of the first and second lens parts 102, 104 to account for the additional thickness of the transparent adhesive material. It should be noted that from an optical point of view the thickness of the transparent adhesive material need not be uniform across the cylindrical surfaces of the waveguide 106 and provided the thickness is non-zero, any variation will have no effect on the total internal reflection of the waveguide 106. In terms of refractive index difference required to achieve total internal reflection in the waveguide 106, a typical example difference between the waveguide and the transparent adhesive may be 0.5. Taking an example refractive index of the transparent adhesive as 1.3 (as given above), the waveguide should have a refractive index 1.8 and for example may be formed of lanthanum glass which would result in a 40-degree field of view (FOV) total internal reflection. It is possible to modify the field of view of the waveguide by appropriate selection of the refractive index of the waveguide, where higher refractive index waveguide materials allow higher field of view.

Alternatively, the waveguide may be formed of BK7 glass which has a typical refractive index of 1.52 and taking this example to achieve the refractive index difference of 0.5 the transparent adhesive should have a refractive index difference of 1.02. SF11 glass, with a refractive index of 1.78 may also be used as a waveguide material. Schott AG also provide waveguide material with a refractive index of up to 2.0 and taking the refractive index difference of 0.5 the refractive index of the transparent adhesive should be 1.5.

Alternatively, and with the requirement of the refractive index difference in mind, there may be an air gap at the interface between the cylindrical surfaces of the first and second lens parts 102, 104 and the waveguide 106. As the skilled person will appreciate that the refractive index of air is 1.0 whilst, as mentioned above, the refractive index of the waveguide 106 should be 1.5. The air gap may thus be seen as a cladding material necessary to achieve the required refractive index difference. In this case in order to mechanically fix the first and second lens parts 102, 104 to the waveguide 106 a small portion of adhesive will be required around the periphery of the lens parts. This small portion of adhesive material will also serve to environmentally seal the airgap from the ingress of contaminants such as moisture. As an alternative to adhesive the air gap may be sealed and the respective parts of the waveguide 106 fixed to the respective part of the first and second lens parts 102, 104 may be heat sealed. In the case of an air gap anti reflection coatings may be applied to the spherical surfaces of the lens parts and/or the waveguide to prevent back reflections and ghost images. In the case of an airgap, the first and second lens parts 102, 104 should ideally be formed of a relatively rigid material such as for example glass, rather than polycarbonate which is relatively flexible. This reduces the chances that the any flexure in the lenses will cause them to contact the waveguide which would result in light leaking from the waveguide 106.

Alternatively, the first and second lens parts 102, 104 may be formed of a low refractive index material and the waveguide 106 may be formed of a high refractive index material and in this way the first and second lens parts 102, 104 may be seen as the cladding material of the waveguide which is necessary to achieve the refractive index difference. In this case spectacle lenses normally require a high refractive index materials to reduce weight. Plastic lenses typically have a refractive index of between 1.3 to 1.8. Typically polycarbonate lenses are 1.5 to 1.6 whereas Trivex (RTM) material is 1.53 or CR39 (RTM) is 1.49. High index plastics are available with a refractive index 1.8. Following the above discussion the skilled person will see therefore that taking the refractive index range of 1.3 to 1.8, a waveguide material with a refractive index of 1.8 to 2.3 is required. Using the Schott AG 2.0 refractive index waveguide material in conjunction with the Trivex (RTM) or CR39 material would provide the necessary minimum refractive index difference of 0.5. As a further alternative the waveguide 106 may comprise a transparent cladding material thereby providing the refractive index difference required for total internal refraction. As yet further alternative to adhesive the first and second lens parts 102, 104 and the waveguide may be heat sealed directly to the waveguide, provided that the refractive index difference can be maintained using one of the options discussed above.

With reference to the above discussion regarding the radii of curvature of the waveguide R₁ and R₂, in practice when an adhesive material is used to attach the first and second lens parts 102, 104 to the waveguide, or where an air gap is utilised, the skilled person will appreciate that the radii of curvature of the waveguide R₁ and R₂ will not be exactly conformal to the radii of curvature of the cylindrical surfaces of the first and second lens parts 102, 104 due to the thickness of the adhesive or air gap. However, the thickness of the adhesive or air gap will be negligible.

FIG. 3 is a schematic diagram of the cylindrical waveguide 106 illustrating the optical properties and as with FIG. 2, the lens parts have been omitted for clarity. In addition to the waveguide 106, an in-coupler 132 is also illustrated. Collimated light rays can be coupled into the waveguide 106 (in-coupled) at an angle β by the in-coupler 132. The light rays incident on the in-coupler 132 are normal to the surface at every point on the surface of the in-coupler 132 and the angle β is such that the angle between the normal and the internal rays in the waveguide 106 is less than the critical angle for the waveguide 106. For example, the angle β will typically be less than 48 degrees. More preferably the angle B will be at least 30 degrees and up to 40 degrees. Light rays, other than the central light ray will be coupled into the waveguide 106 at a slightly different angle, for example β+1, however this angle will be consistent at every point along the surface of the in-coupler 132. The in-coupler 132 may be a diffraction grating or a holographic grating.

The skilled person will appreciate that the light rays may originate from an image source S located at the centre of radius of curvature X of the concentric surfaces of the waveguide 106. The light rays from a central pixel of the image source S may be collimated in one plane by the collimation lens 135. This collimation of rays is a form of wavefront shaping to couple the collimated rays into the waveguide as described above.

When the opposing surfaces 108, 110 of the waveguide 106 are concentric as illustrated in FIGS. 2 and 3 the angle of incidence of a light ray on the outer surface 108 is the same after reflection on the inner surface opposing surface 110 and therefore the light ray will retain its direction angle at it propagates through the waveguide 106, which is not the case for arrangements of curved waveguides which do not have concentric surfaces. As illustrated in FIG. 3, if the angle of incidence is α with the world facing surface 108 then the angle of incidence with the eye facing surface 110 will be β and the subsequent angle of reflection from the world facing surface 108 will be α. In other words, the angles of incidence inside the waveguide are the same on every alternate reflection from a respective surface of the waveguide 106. Light rays from a pixel incident on the left, centre or right of the in-coupler 132 will approach the inner surface at the same angle throughout the waveguide after reflection from the world facing surface 108. Pixels other than the central pixel will have different values of a and B but the relationship of incidence and reflection set out above is still valid.

It has been recognised that, by causing all the light rays originating from the same point on the image surface to be incident on the cylindrical waveguide 106 at the same angle, a high performance and compact optical system can be implemented. As an example, taking a display with a brightness of 100,000 nit (cd/m²) the output brightness at the output (from the point of view of a user) would be in the region of 10,000 nit, which corresponds to a system efficiency of 10% and losses here may be primarily attributed to losses in the in- and out-coupling diffraction gratings 132, 134.

In the present disclosure, although the central ray angle is discussed, there may be other light ray angles generated by an image source S, such as for example a micro-display or a laser beam scanning projector which can be expanded and collimated for use in a waveguide, and when in use generate the field of view of an image to be viewed by a user. These other light ray angles propagate through the waveguide 106 in the same manner as the central light rays with the exception that there will be some loss of image quality or aberrations of the rays at the edges of the field of view, or edges of the image, but such aberrations will largely not be noticeable to the user provided they can be kept under 1 arc minute, which is the limit of human acuity. In any event aberrations can be compensated by optical means such as multiple element, large, high quality, aspheric, long focal length collimation optics to reduce aberrations at the edges of the field. Advantageously, aberrations do not accumulate with the number of internal reflections within the waveguide 106. For example, if a light ray from a given pixel is in-coupled into the waveguide 106 at an angle of 60±0.1 degrees, then after any number of reflections and pupil replications the angular resolution of the waveguide 106 and in-coupling optic will still support ±0.1 degrees resolution no matter how the light rays swap or shuffle. This contrasts with waveguides that accumulate aberrations that along their length of transmission.

FIG. 4 illustrates a schematic top-down view of the waveguide as illustrated in FIGS. 2 and 3, with the exception that an out-coupler 134 is included. The out-coupler 134 may be a diffraction grating or a holographic grating applied on the surface of the waveguide 106, and the out-coupler 134 is preferably matched with the in-coupler 132. That is, the central guiding angle of the waveguide (in other words the TIR angle for the central pixel, central ray) for the in- and out-coupler are the same, and the same wavelength. For reference purposes only, in FIG. 4, the plane of the page (and any plane parallel thereto) is considered to be a horizontal plane. Likewise, the perpendicular plane out of the page (and any plane parallel thereto) is considered to be a vertical plane. In this way the cylindrical waveguide can be considered to be a cylindrical visor, or the like, on a flat surface. As previously discussed, an image source S may be located at the centre of radius of curvature of the concentric surfaces of the waveguide 106 and the collimated in one plane (in this example, the vertical plane) by the collimation lens 135. Light rays entering the waveguide 106 from the in-coupler 132 will propagate, as described above, along the waveguide with rotational symmetry. In other words, the waveguide as illustrated in FIG. 4 can be rotated about the cylinder axis and light rays from a given pixel will maintain the same angles with respect to the cylindrical surfaces of the waveguide. This rotational symmetry makes the waveguide invariant to the location of placement of the out-coupler 134 on the waveguide 106, thus eliminating the need for precise alignment of the out-coupler 134 on the waveguide 106. Light collimated in one plane by the collimation lens 135 therefore enters the waveguide 106 at the in-coupler 132 and propagates through the waveguide 106 and then exits the waveguide 106 at the out-coupler 134 to provide light to a user's eye.

The waveguide 106 allows for spherical wavefronts from the light source S to be conformed in a horizontal plane to the curvature of the waveguide 106 by itself and power is added in the vertical plane by the cylindrical lens 135. This means that after two reflections of light ray in the waveguide 106, the light ray maps back onto itself and this repeats indefinitely. Therefore, the pupil can be replicated and expanded to expand the eye-box in one-dimension (in this case the horizontal). The collimation lens 135 may be incorporated in the augmented reality eyeglass lens system, as discussed below, or it may be provided externally, such as in the display projector system. The size of the vertical eyebox is set by the vertical size of the cylindrical lens 135. It also relaxes the alignment tolerances (as the position of the out-coupler relative to the input pupil is not critical the choice of the thickness of the waveguide and the central ray guiding angle. If vertical replication is required, a so-called “turn grating” to expand the eyebox vertically may be used.

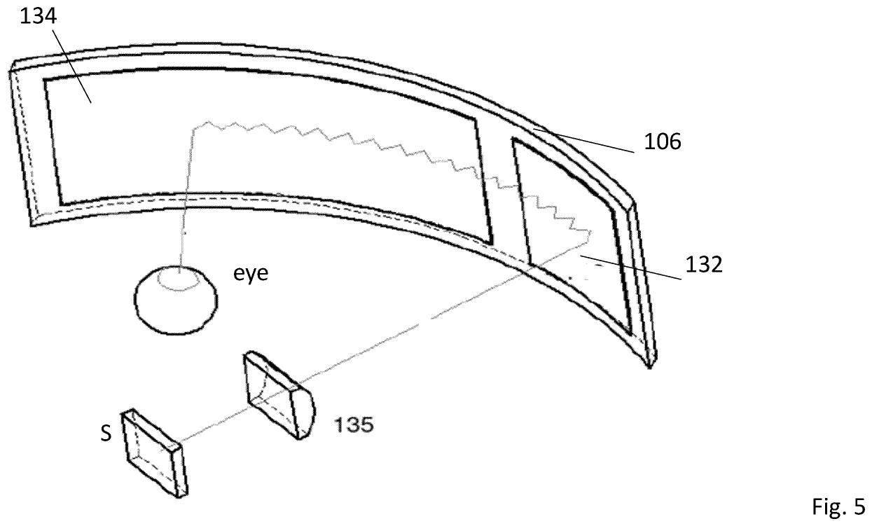

Referring to FIG. 5, there is illustrated a perspective view of a curved waveguide 106 of the eyeglass lens 100 according to an embodiment. Again, the first and second lens parts have been omitted for clarity. Light rays from the image source S, which in this case may be a micro-display, are collimated in one plane by the collimating lens 135 and coupled into the waveguide 106 by the in-coupler 132. Light rays propagate through the waveguide 106 and are coupled out to a user's eye by the out-coupler 134. The image source S is at a distance from the waveguide 106 that is the same as the radius of curvature of the waveguide on which the in-coupler 132 is applied (R₁ in this example) and this distance is achieved by either physically positioning the image source S at this distance, or by virtually placing the image source at this distance by optical means, using lenses for example. The image is collimated in one plane by the collimation lens 135, which may for example be a cylindrical planoconvex lens, onto the in-coupler 132 positioned on the concave inner surface of the waveguide 106. The collimating lens 135 is oriented such that the focusing power of the collimating lens is in the opposing plane compared to the waveguide 106. If the waveguide 106 is orientated horizontally (as illustrated) it has power in the vertical plane and would reflect light from a point source at the radius of curvature into a vertical line. The collimating lens 135 is then oriented in the opposing vertical plane and has power in a vertical plane to focus light from a point source at the radius of the curvature of curvature into a horizontal line. The light rays bearing image information are thus collimated in one plane only (horizontal) before entering the waveguide 106 and the curvature of the waveguide 106 conforms the light in a perpendicular (vertical) plane. This allows the entire pupil of light entering the waveguide to propagate along the waveguide 106 and thus allow for pupil expansion from the out-coupler 134 at the output to the user's eye.

The focal length of the collimating lens 135 determines the magnification of the object, and the lens 135 is set a distance of one focal length away from the source S. If the cylindrical lens 135 were placed next to the cylindrical waveguide 106 then it would have a focal length approximately equal to the radius of curvature of the waveguide. For example, a typical radius of curvature of a visor-shaped waveguide of 200 mm would mean the object was 200 mm away and the cylindrical lens had a focal length of 200 mm. The distance of 200 mm from waveguide to object can be reduced for compactness either by folding the optical path with mirrors or optically setting the object distance virtually using lenses.

The choice of collimating lens 135 (diameter and/or focal length) determines the size of the vertical eyebox (determined by the diameter of the lens) and the focal length determines the magnification of the source S and hence the field of view (FOV) of the image (along with the size of the display). Typically, a multi element lens is used for collimating lens 135 (such as used in a camera) which provides for a good image quality across the whole FOV (small spot size RMS across the whole field). This is especially desirable for pupil replication systems to overlap the pupils precisely and provide a high-resolution image. The lens system is ideally achromatic for a full colour micro-display, although monochrome solutions are possible. The FOV of the curved waveguide 106 may largely be determined by similar factors, but due to the nature of the curve around the user, the FOV will be expanded compared to a planar waveguide.

The in-coupler 132 may be a diffraction grating which is a linear grating and which has equal surface spacing (pitch) between grating lines (or equivalently, equal fringe spacing in a volume holographic grating). The grating can be made lithographically or interferometrically. All rays collimated in one plane, which are normally incident (90 degrees to surface) across the width of the grating surface, are then diffracted at the same angle inside the waveguide and this allows for pupil replication.

A grating on a curved waveguide typically means that the collimated light is not normally incident across the grating width due to the curve of the waveguide. Typical solutions to this involve varying the pitch of the grating to compensate for this, or recording a hologram directly on a curved surface, or lithographically etching on a curved surface, which is complicated and expensive. In the preferred embodiment according to the present disclosure, the in-coupler grating 132 is fabricated as a planar linear grating on a flat substrate (as is well known in the art and is relatively inexpensive and straightforward to manufacture compared to variable gratings). The in-coupler grating 132 can be made on any flexible holographic material, for example a photopolymer (for instance, Bayfol (RTM) as marketed by Covestro AG or a silver halide film), then attached (laminated) onto the cylindrical surface of the waveguide, conforming to the cylindrical surface. The in-coupler grating 132 is index matched, preferably by lamination (or another index matching glue or liquid), such that it conforms to the shape of the cylindrical surface and desirably, such that there is no air gap. It is straightforward and inexpensive to record a hologram on a flat substrate and then remove and laminate the flexible holographic material on a planar or cylindrical substrate (curved in one dimension only), whilst it is more difficult to record on a curved surface or laminate on a spherical surface (curved in two dimensions). It may also be possible to etch slanted gratings and use embossing or UV-curing resin techniques. The grating may then be transferred onto the cylindrical waveguide.

The in-coupler grating 132 pitch is designed to diffract the central wavelength of the source S. As the in-coupler grating 132 is nominally designed to diffract normal incidence light at an angle, the in-coupler grating 132 has an inclination angle, and the pitch is normally specified as the separation between gratings as measured along the planar surface of the grating. This is kept constant, that is a linear grating, for the input coupler grating 132.

For known planar waveguides, both couplers are typically linear and identical. The system then behaves like a periscope and the magnified image of a micro-display is presented to the viewer overlaid on the real world. The design of the system as a whole means that the positional pixel information of the display is converted via collimation to angular information and then returned to positional information at the human retina. As with the in-coupler 132, the out-coupler 134 may also be a diffraction grating which has a variable period along the waveguide and where the light source S is a broadband source does not cancel chromatic aberrations in every place. However, the period of the grating at the centre can be chosen to be identical the input grating period to minimise such aberrations.

Alternatively, narrow band sources such as a laser light source, super-luminescent light emitting diodes (SLEDs) or notch filtered narrow band LEDs can be used. A narrow band source may help to minimise chromatic aberration. They may also limit the FOV of the output image, but thin holographic volume gratings can be used to mitigate this. For example, typical thicknesses of the holographic volume gratings may be at least 3 microns and up to 6 microns. The thickness of the holographic volume grating can be chosen dependent on the required diffraction efficiency (DE) and FOV. Where increasing the thickness will provide a higher DE but lower the FOV. This may provide a typical spectral bandwidth of approximately 20 nm full width half maximum (FWHM) and an angular bandwidth in air of approximately 6 degrees FWHM.

The out-coupler grating can be chosen to place the digital image at any distance from the viewer by adding more focussing in both planes. In a vertical plane, the light in-coupled to the waveguide is collimated, but the light output from the out-coupling grating need not be collimated. To allow for multiple pupil extraction, only part of the light may be extracted at the first part of the out-coupler grating 134. To balance the uniformity of the light extracted across the out-coupler grating 134, the far end of the out-coupler grating 134 (with reference to the in-coupling grating 132) desirably has higher efficiency than the near (receiving) end. The diffraction efficiency (DE) of the output grating is advantageously chosen low enough to allow enough pupil replication (for example, 5-25%) at the receiving end of the output grating 134, but high enough at the far end for satisfactory brightness (for example, 10-100%).

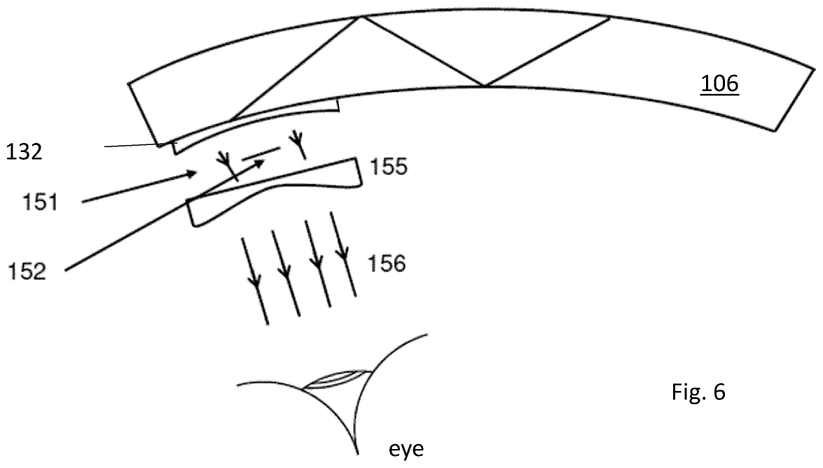

With reference to FIG. 6, there is depicted a schematic top-down view of the cylindrical waveguide 106 and a simplification of the out-coupling optics, including out-coupler 134 which may be a diffraction grating. As with FIG. 4, the plane of the page (and any parallel plane) in this drawing is considered horizontal and the perpendicular plane coming out of the page (and any parallel plane) is considered vertical. The cylindrical waveguide 106 can therefore be visualised, for example, like a cylindrically shaped visor on a flat surface. Also shown in this simplification is a cylindrical negative lens 155, as will be discussed further below. Rays 151 output from the out-coupling diffraction grating 134 are collimated in a vertical plane and focused in a horizontal plane, as indicated by line 152. Rays 156 output from the cylindrical negative lens 155 are collimated in both the x-horizontal plane and the y-vertical plane and have infinite focus. This is a simplification, as the cylindrical negative lens 155 is actually optically integrated within the out-coupling diffraction grating 134. The power is thereby contained within the out-coupling diffraction grating to compensate and achieve collimation in both planes at the output. The out-coupling diffraction grating 134 thereby functions as a cylindrical lens to compensate for the cylindrical curvature introduced by the in-coupling optics and, in this way, essentially collimates the image at infinity, as is explained below.

Due to the asymmetrical collimation at the in-coupling optics, the out-coupling optics compensate for the different focal positions of the horizontal (near) and vertical (far or infinity) output image planes to provide an image focused at infinity in both planes, thereby providing a high-quality image to the viewer. The compensation is achieved by encoding optical power into the output grating. As shown in FIG. 6, it is the equivalent of placing a diverging cylindrical lens 155 with negative power equal to the radius of curvature of the waveguide between a planar output grating and the user (a planoconcave cylindrical lens; if the radius of curvature of the waveguide was 200 mm then the focal length of the lens would be 200 mm). The lens 155 is oriented perpendicular to the input collimating lens 135. If the collimating lens 135 focused (or has power) in a vertical plane the output compensating lens/grating will focus (or has power) in a horizontal plane to create a spherically collimated output. As discussed above, the centre of the out-coupling grating 134 has the same surface pitch (also known as lateral or in-plane pitch) as the input grating to allow for chromatic dispersion compensation.

The image appears to the user at infinity. This is typically the desired use case, as it means that the virtual image will appear in focus when the user is focused on far objects in the real world, as is typical when using a visor, for example, a fighter pilot or motorbike rider. Consumer devices that use planar waveguides with pupil expansion also have the image at infinity. Alternatively, rather than setting the image at infinity as discussed, it is possible to set the virtual image closer to the user by the addition of negative power in the out-coupler. For example, 1 dioptre of negative power in the holographic out-coupler sets the image at 1 meter rather than infinity which may be useful if a user wants the virtual image overlaid at the same focal plane as for example at arm's length.

The output grating 134 can have a varying diffraction grating efficiency, or a relatively low output efficiency (for example, 10%). This can be achieved during recording of the holographic out-coupler. While it is desirable for the input grating 132 to have maximum diffraction efficiency (meaning that the majority of light incident on it is in-coupled into the waveguide), the output grating 134 can have a low or variable efficiency, allowing for pupil expansion. A small fraction of the light is outcoupled at the first interaction with the output grating 134, while a large fraction carries on bouncing down the waveguide and a part of that light is output at the second interaction and so on. This allows for an expanded eyebox in a horizontal plane.

The holographic waveguide grating (either linear out-coupler or powered out-coupler) can be fabricated by exposing a holographic material to two coherent light beams, with the waveguided beam coupled into the material via a prism, as is known in the art. Lasers of three different wavelengths (for example, red, green and blue, RGB) can be used to multiplex three gratings into a single holographic layer to allow a substantially white image to be seen by the viewer from an RGB micro-display. Alternatively, three separate layers can be stacked, one for each colour.

The FOV provided to the user, across which a uniformly bright, chromatically uniformly image can be seen, can be increased by multiplexing multiple gratings into a single holographic layer. This may be achieved by varying the recording angles. Alternatively, multiple angularly multiplexed layers can be stacked.

The input and output gratings can be reflection holograms, transmission holograms or any combination thereof. This will be appreciated from the theory above, as the desired effect is only based on the lateral component of the grating pitch. The transverse (cross-sectional) pitch or period can be chosen conveniently to suit reflection or transmission grating geometry. It can also be appreciated that the above-mentioned linear grating means linear in the lateral direction but can have variable transverse properties.

The collimated nature of the output light means a large eye relief (that is, distance the eye can be behind the output surface and optimally see the image) can be achieved. This is often desirable, especially for applications with helmet visors rather than glasses. The greater the eye relief, typically the smaller the FOV.

The real-world view will be largely unchanged by the curve of the waveguide. A radius of curvature of 250 mm is normal for glasses, and 150-200 mm for a visor. Any curvature greater than 100 mm (as is the case here) will not be noticed by the user as an effect on distorting the real world. There will be only a very small astigmatism effect, unless compensated by an additional overlaid lens (or lenses).

Returning to generalised senses of the disclosure, the out-coupling optics may be considered to comprise an out-coupling diffraction grating. In particular, the out-coupling diffraction grating may be configured to act as a cylindrical lens (for example, focusing in only one dimension). Additionally or alternatively, the out-coupling linear diffraction grating may have curved gratings. In preferred embodiments, the out-coupling linear diffraction grating may have internal grating angles arranged to collimate received light in a plane or to focus received light in tangential and sagittal planes at a predetermined distance and/or an output or diffraction efficiency at an end of the out-coupling diffraction grating nearest light received from the input optics of no more than 25% (optionally, 20%, 15% or 10%).

The out-coupling optics may comprise an output wavefront shaping device configured to collimate received light in a single plane that is orthogonal to the single plane of the input wavefront shaping device. Additionally or alternatively, the out-coupling optics may comprise a cylindrical negative lens. Preferably, such aspects are integrated in the out-coupling diffraction grating.

The out-coupling linear diffraction grating may have the same surface pitch as the in-coupling linear diffraction grating. In some embodiments, the out-coupling linear diffraction may have internal grating angles that are oppositely orientated in comparison with internal grating angles of the in-coupling linear diffraction grating. This is particularly used where the light from the image source and the light to the viewer (or the in-coupling optics and the out-coupling optics) are on the same side as each other. This may be termed a ‘U’ grating. Alternatively, the angles of the in-coupling grating and out-coupling grating are not oppositely oriented, at least some light will be out-coupled on the opposite side to the in-coupled light (in other words, the viewer would be on the other side compared with the in-coupled light). This may be termed a ‘Z’ grating.

From an alternative perspective, it is also possible to explain the approaches according to the present disclosure in terms of symmetry. The approaches use a cylindrical waveguide and a cylindrically symmetric wavefront, both rotationally symmetric around their common axis.

Consider a pixel on a display or other image generating means. It is possible to shape the light wavefront from this pixel to be a cylinder. A linear diffraction grating recorded on flat substrate and laminated onto a cylindrical waveguide will have a constant period along the surface. Then, every ray will be deflected by the same angle, resulting in the light field being symmetric around the rotation axis. As explained above, a ray launched between cylindrical surfaces will preserve the two angles of incidence onto the two surfaces at any number of bounces. This means that, after every two reflections, the wave will coincide with itself exactly. No double image is thereby generated. Such a light-field can propagate any distance without any ray becoming different from other rays.

Also, pupil replication at the output grating is achieved. Partial out-coupling of the light happens at an initial interaction with the out-coupling optics, leaving the remaining light to propagate and couple out at the next interaction. In this case, different interactions perfectly match without causing ghost images. When all the rays arrive at the out-coupling grating, the grating can diffract them out of the waveguide no matter the position of the grating or position of any one ray, because they will all arrive alike.

Using a linear out-coupling grating with the same period as that of the in-coupling grating diffracts the rays again into a new cylindrical wavefront. It is well known that diffractive optical elements can combine several functions in additive manner. The out-coupling grating also has a focussing power in one dimension, like that of a cylindrical lens. This will convert diffracted light into a collimated light. An observer receiving such light will experience a star-like point at infinity.

The above explanation can be repeated for other pixels. As identified above, the wavefronts from these other pixels need not be precisely cylindrical. This occurs because rays from non-central pixels are incident on the in-coupling optics at a slightly different angle than the ‘perfect’ normal (perpendicular) angle. However, by all hitting the in-coupler at substantially the same angle with respect to the surface normal at their respective points of intersection, the resulting rays will form a field of rays rotationally symmetric around the cylindrical axis and propagate in an undistinguishable manner. Using modern optical design it is possible to design projectors forming such light fields with small error, ideally 1 arc minute (human acuity).

Where the eye facing surface of the second lens part 104 is concave and that there is an air gap or a transparent adhesive between the waveguide 106 and the second lens part 106, then the second lens part will add converging power to the light coming out of the out-coupler so further negative (diverging) power would need to be added to compensate for this. That is, the out-coupler would need to have more negative power (it may already have some negative power as discussed above). If the amount of negative power equal to the inner surface radius of curvature was added the virtual image would stay at infinity. For the second lens part 104 the world facing surface may be cylindrical. Similarly, where the second lens part 104 eye facing surface is spherical, then spherical negative power may be added to the out-coupling grating as well as cylindrical power. It should be noted that the in-couplers could be transmission or reflection geometry, although reflection types are normally used for practical reasons. Whilst in the figures the in-coupler appears to function as a transmission hologram in fact they are reflection holograms, in that the light passes through the hologram and bounces off the outer hologram surface and is then diffracted in reflection geometry (for the out-coupler).

The orientation of the cylindrical waveguide can be varied. The embodiments described above relate to the cylinder axis of the cylindrical waveguide oriented vertically (and the cylindrical waveguide therefore extends in the horizontal direction), as it is the normal way of aligning visors. Other orientations can be considered. Additionally or alternatively, light may enter and exit the cylindrical waveguide through different surfaces, for example on different sides of the waveguide. The in-coupling grating and out-coupling grating can be positioned accordingly to achieve this. More than one in-coupling grating and/or out-coupling grating may be provided in some embodiments.

The in-coupling and out-coupling gratings can each be a reflection or transmission grating and can be placed on the inner or outer surface of the waveguide (or another surface of the waveguide). The skilled person will understand such variations to the embodiments shown herein.

Furthermore, it is known that the human eye seems to prefer viewing horizontal aspect ratios (for example the aspect ratio of a TV set is optimised for this) and lenses of glasses are mostly horizontal aspect ratios, the aspect ratio of the out-coupler is matched the lens aspect ratio. Also the fact that IPD varies more horizontally than vertically, a larger horizontal eyebox rather than vertical eyebox is advantageous for users.

The input pupil is the twice the width of a single bounce, so the edge rays do not overlap with the in-coupler grating. The optimal pupil width is set by the waveguide thickness and the guiding angle and is approximately twice the thickness of the waveguide. So, a very thin waveguide means a very small pupil (0.5 mm thick=1 mm pupil), and therefore you need to overlap many pupils at the out-coupler grating to get a large eyebox.

The linear input grating can have any angle of orientation. The light need not be redirected in the cylinder circumferential direction (perpendicular to the cylinder axis, which is horizontal in the embodiments described above). It can be directed along the cylinder axis (vertical). Alternatively, it can be directed at 45 degrees or any other diagonal direction. This allows design freedom, for instance to position the projection module conveniently at the temple of glasses (eyeglasses). This is also significant for realisation of intermediate gratings for 2D pupil expansion. An intermediate linear grating may redirect and/or split the light, whilst keeping respective angles for each of the redirected rays the same for rays from the same pixel.

The system allows for either laser or LED light to be used, which allows flexibility. Typically, LED light is used, for example a LCOS (Liquid Crystal on Silicon) plus LED or a microLED micro-display, but laser light can also be used if high efficiencies and hence high brightness are desired. A laser beam mirror scanning system (MEMS), micro-optoelectro-mechanical system can also be used. Laser light has some disadvantages in terms of cost, speckle (a loss of resolution) and eye safety concerns.

If a refractive element (for example, a prism) is used as the in-coupler or out-coupler along with a diffractive in-coupler or out-coupler, then the uncompensated chromatic dispersion may be such that only a narrow band source can be used (for example, a laser). Additionally, refractive couplers tend to be bulky and expensive.

It is possible to set the virtual image at different focal distances by adding spherical optical power to the waveguide output. It is also possible to set the focal distance closer with an extra pair of lenses before and after the waveguide (second lens to compensate for the effect of the first lens on the real world). A further possibility is to add electrically addressable switchable (liquid crystal based) holographic output gratings, which can be switched on or off to provide different focal planes for the image. Additionally or alternatively, the input grating may be switched in the same way to provide a larger FOV, as can be achieved with angularly multiplexed gratings. The switching can be synchronised with a time-multiplexed microdisplay.

Optionally, multiple focal planes may be realised by using multiple (stacked) cylindrical waveguides. Light would propagate as discussed above but exit with gratings producing different foci. Further adding to the output of the cylindrical waveguide an axially symmetric power, like that of an ordinary spherical lens, will result in experiencing the point at a finite distance, say 1m.

The cylindrical waveguide may form part of a larger (integral) waveguide structure, only part of which may be cylindrical. Embodiments can be considered in which in-coupling optics are not required. For example, light may enter the waveguide through or originate in the waveguide at (for example, due to an embedded image source) a portion of the waveguide that is not cylindrical and the wavefront shaping may be carried out in this portion. This portion of the waveguide may therefore form part of the input optics.

The vertical eyebox can also be expanded by multiple input projectors vertically displaced. Typical approaches used to extend the vertical eyebox in planar waveguides use ‘turn’ gratings which propagate the pupil vertically to give 2D exit pupil expansion. There are various methods to expand the eyebox vertically, including an input, turn and output grating such as implemented in products by Vuzix Corporation or DigiLens Inc. An alternative is to use a ‘butterfly’ turn grating, which expands the eyebox and also expands the FOV by splitting the FOV into two at the input and recombining at the output (as used by HoloLens (RTM) marketed by Microsoft Corporation. A further option is to use a reciprocal multiplexed grating, which waveguides part of the light and out-couples part of the light across an expanded eyebox (as used in products by WaveOptics, Ltd).

All these existing techniques benefit from the use of collimated light routed by linear gratings and a flat waveguide. According to the present disclosure, which uses a cylindrical waveguide, these techniques of splitting the light and replicating the pupil by intermediate linear gratings may be implemented after the in-coupling of the light into the cylindrical waveguide. Then, the light may be finally out-coupled with the grating having a negative cylindrical focussing function.

The rotationally symmetrical structure of embodiments in accordance with the disclosure allows the input grating and output grating to be placed anywhere on a concentric cylindrical waveguide. For example, as well as the typical planar horizontal configuration discussed above, the orientation could be vertical or at angle across the waveguide (for example, in a visor implementation). This allows for flexibility in placement of the projector and eyebox location in the final design. It also allows for pupil replication and vertical eyebox expansion methods discussed in the previous paragraphs.

In embodiments, the wavefront shaping device may comprise a concave (cylindrical) mirror. Optionally, the image source and/or an image source mounting may be located closer to the outer surface of the cylindrical waveguide than the inner surface of the cylindrical waveguide. Then, a mirror (which is preferably the wavefront shaping device) may be arranged to receive light from the image source and reflect the received light towards the cylindrical waveguide. In some embodiments, the mirror and the image source and/or image source mounting are configured such that light from the image source passes through the cylindrical waveguide before reaching the mirror. In certain embodiments, respective parts of the input optics proximal the cylindrical waveguide (for example, an in-coupling grating) and out-coupling optics proximal the cylindrical waveguide (for example, an out-coupling grating) are on opposite sides of the cylindrical waveguide.

In certain embodiments, the input optics further comprises one or more spherical lenses. Additionally or alternatively, the out-coupling optics further comprises one or more spherical lenses. A spherical lens may be used to change the optical path length of the light and/or to change the focusing of the light.

In embodiments, the input optics may further comprise a waveguide portion that is integral with the cylindrical waveguide. Beneficially, the waveguide portion forming at least part of the input optics is non-cylindrical and/or does not have concentric surfaces. Only part of the waveguide shape may be cylindrical in some embodiments.

One or more intermediate optical gratings may be provided in the cylindrical waveguide in some embodiments. One, some or all of the one or more intermediate optical gratings may be linear. The intermediate optical grating or gratings may be arranged to redirect, diffract and/or split light before the out-coupling optics. The relative angles of the light rays from the same pixel are advantageously kept the same, however. The intermediate optical linear grating advantageously preserves the angular properties of the propagating light (TIR condition and that all rays from the same pixel are incident on the cylindrical waveguide surface at the same angle relative to the surface normal and at the same angle relative to a plane normal to the cylinder axis), thereby allowing for two-dimensional pupil expansion without aberration.

The out-coupling optics may comprise an out-coupling diffraction grating having one or more of: internal grating angles arranged to refract received light; a variable diffraction efficiency along a length of the out-coupling diffraction grating; and a switchable diffraction grating configuration (for instance, allowing modulation of the output light). Optionally, the in-coupling diffraction grating may have a switchable diffraction grating configuration.

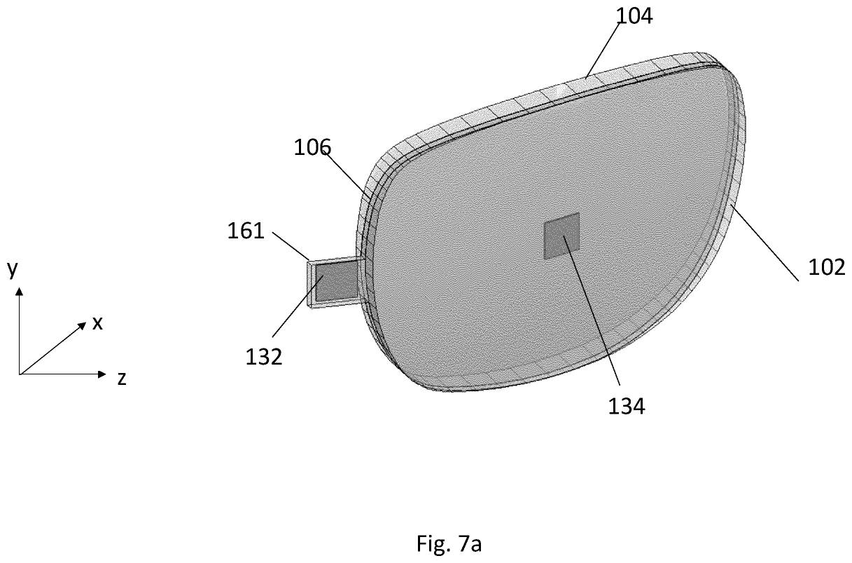

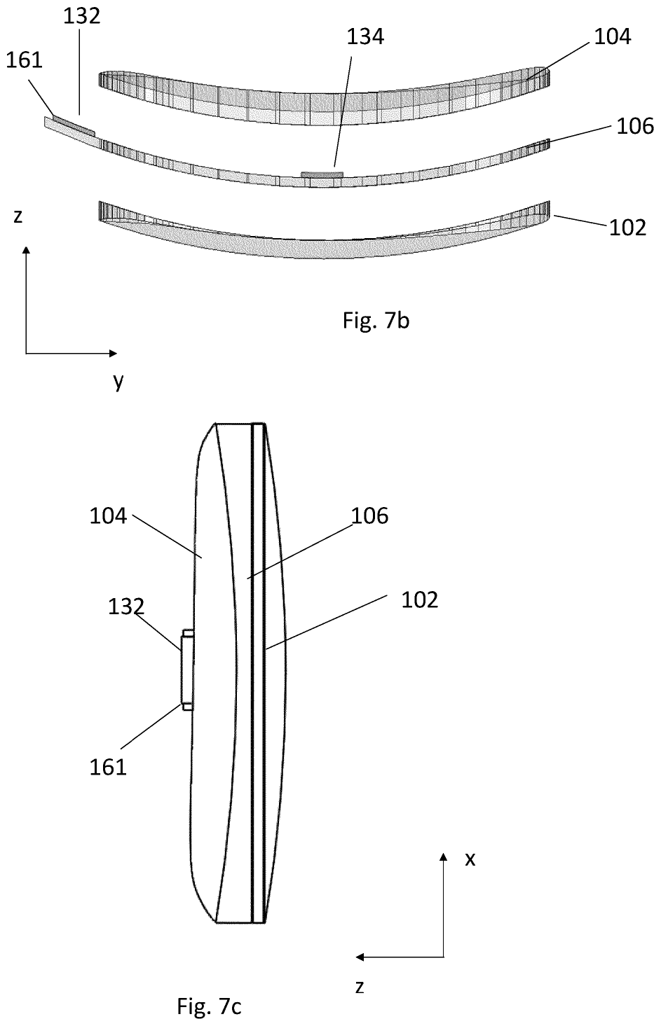

An alternative arrangement to the eyeglass lens discussed above is illustrated in FIGS. 7a to 7c, the difference being that the waveguide 106 extends outside of the area of the first and second lens parts 102, 104 as an in-coupling tab 161. The in-coupler 132 may be formed or fixed on the in-coupling tab 161 and typically the in-coupling tab will be formed on the side of an AR glasses frame which comprises the input light source. Additionally, in-coupling optics such as the collimating lens 135 may be arranged on the in-coupling tab 161.

Multiple cylindrical waveguides may be provided. For instance a second cylindrical waveguide, having concentric inner and outer surfaces may be provided. The first and second (or multiple) cylindrical waveguides may be stacked. Some or all of the multiple cylindrical waveguides may have a common cylinder axis. In all such cases, the input optics may be arranged to cause some of the received light to enter each of the multiple cylindrical waveguides, such that for each cylindrical waveguide, all rays originating from the same pixel of the image source are incident on a surface of the respective cylindrical waveguide at the same angle relative to the surface normal and at the same angle relative to a plane normal to the respective cylinder axis, at each point of incidence, the in-coupled light thereby retaining its direction angle as it propagates along the respective cylindrical waveguide. Beneficially, out-coupling optics may be arranged to focus light propagated along each of the cylindrical waveguide at different foci. For instance, the out-coupling optics may be arranged to focus light propagated along the first cylindrical waveguide at a first focus and to focus light propagated along the second cylindrical waveguide at a second, different focus. Embodiments may be considered with multiple image sources, which are advantageously vertically displaced from one another.

1. An eyeglass lens for an augmented reality display, the eyeglass lens comprising:
a first lens part and a second lens part, with a cylindrical waveguide therebetween;
the cylindrical waveguide having cylindrical concentric opposing surfaces defining a first cylindrical interface with the first lens part and a second cylindrical interface with the second lens part, and wherein the cylindrical waveguide is transparent and comprises central waveguide core with a transparent medium at the first and second cylindrical interfaces.

2. The eyeglass lens of claim 1, wherein the central core has a higher refractive index than the transparent medium.

3. The eyeglass lens of claim 1, wherein the transparent medium is an adhesive material or is an air gap.

4. The eyeglass lens of claim 1, wherein the first lens part, second lens part, cylindrical waveguide and transparent medium are arranged as an optical stack.

5. (canceled)

6. The eyeglass lens of claim 1, wherein the eyeglass lens has a major axis and a minor axis, the first and second cylindrically shaped interfaces having a curved profile along the major axis.

7. The eyeglass lens of claim 6, wherein the first and second cylindrically shaped interfaces have a linear profile along the minor axis, and wherein the first lens part and the second lens part have a spherical outer profile.

8. (canceled)

9. The eyeglass lens of claim 1, further comprising input optics, wherein the input optics are configured and arranged to couple light into the cylindrical waveguide.

10. The eyeglass lens of claim 9, wherein the input optics comprises an in-coupling linear diffraction grating having a constant period, applied to a surface of the waveguide.

11. The eyeglass lens of claim 10, wherein the in-coupling linear diffraction grating is attached to the waveguide at the first cylindrical interface or the second cylindrical interface.

12. The eyeglass lens of claim 10, wherein the in-coupling linear diffraction grating is switchable.

13. The eyeglass lens of claim 10, wherein the in-coupling linear diffraction grating is formed of a holographic material.

14. The eyeglass lens of claim 9, wherein the input optics are configured and arranged to receive light rays from an image source and to cause the light rays to enter the cylindrical waveguide so that all light rays originating from a same pixel of the image source are incident on the surface of the cylindrical waveguide at the same angle relative to the surface normal and at the same angle relative to a plane normal to the common cylinder axis, at each point of incidence, the in-coupled light thereby retaining its direction angle as it propagates along the cylindrical waveguide.

15. The eyeglass lens of claim 1, further comprising output optics configured and arranged to receive propagated light from the cylindrical waveguide and present the light as an image to a user's eye.

16. The eyeglass lens of claim 15, wherein the output optics comprises an out-coupling linear diffraction grating having a constant period, applied to a surface of the waveguide.

17. The eyeglass lens of claim 16, wherein the out-coupling linear diffraction grating is attached to the waveguide at the first cylindrical interface or the second cylindrical interface.

18. The eyeglass lens of claim 16, wherein the out-coupling linear diffraction grating is switchable.

19. The eyeglass lens of claim 16, wherein the out-coupling linear diffraction grating is formed of a holographic material.

20. The eyeglass lens of claim 16, wherein the out-coupling linear diffraction grating is attached to the waveguide at the first cylindrical interface or the second cylindrical interface.

21. A method of manufacturing an eyeglass lens for an augmented reality display, the method comprising;
forming a first lens part and a second lens part and inserting a cylindrical waveguide therebetween;
forming the cylindrical waveguide with cylindrical concentric opposing surfaces defining a first cylindrical interface with the first lens part and a second cylindrical interface with the second lens part, and wherein the cylindrical waveguide is transparent and comprises central waveguide core with a transparent medium at the first and second cylindrical interfaces.

22. The method of claim 21, wherein the central core has a higher refractive index than the transparent medium.

23. (canceled)

24. (canceled)

25. (canceled)
